(19) United States
(12) Patent Application Publication
(10) Pub. No.: US 2025/0245499 A1
(43) Pub. Date: Jul. 31, 2025

(54) EPISTEMIC MACHINE LEARNING MODELS

(71) Applicant: DeepMind Technologies Limited, London (GB)

(72) Inventors: Ian David Moffat Osband, London (GB); Zheng Wen, Fremont, CA (US); Seyedmohammad Asgharipari, Sunnyvale, CA (US); Vikranth Reddy Dwaracherla, Mountain View, CA (US); Xiuyuan Lu, Mountain View, CA (US); Benjamin Van Roy, Stanford, CA (US)

(21) Appl. No.: 18/856,200

(22) PCT Filed: Apr. 13, 2023
(86) PCT No.: PCT/EP2023/059619

§ 371 Date: Oct. 11, 2024

Related U.S. Application Data
(60) Provisional application No. 63/330,767, filed on Apr. 13, 2022.

(51) Int. Cl. G06N 3/08

(52) U.S. Cl. CPC G06N 3/08

(57) ABSTRACT

Methods, systems, and apparatus, including computer programs encoded on computer storage media, for processing inputs using an epistemic machine learning model that improves the quality of outputs generated by a base machine learning model.

### BACKGROUND

This specification relates to processing inputs using machine learning models.

As one example, neural networks are machine learning models that employ one or more layers of nonlinear units to predict an output for a received input. Some neural networks include one or more hidden layers in addition to an output layer. The output of each hidden layer is used as input to another layer in the network, e.g., the next hidden layer or the output layer. Each layer of the network generates an output from a received input in accordance with current values of a respective set of weights.

### SUMMARY

This specification describes a system implemented as computer programs on one or more computers that performs a machine learning task by processing inputs using an epistemic machine learning model.

The subject matter described in this specification can be implemented in particular embodiments so as to realize one or more of the following advantages.

Conventional machine learning models, e.g., neural networks, generate marginal predictions that cannot be used to distinguish between aleatoric uncertainty and epistemic uncertainty. That is, an output of a conventional machine learning model for a given input that is ambiguous, i.e., that assigns significant probability mass to more than one possible output, does not indicate whether the output is ambiguous due to aleatoric or to epistemic uncertainty.

Aleatoric uncertainty refers to uncertainty that cannot be resolved by training the machine learning model on more or different data, e.g., because the input is ambiguous and cannot be accurately classified or accurately modeled.

Epistemic uncertainty refers to uncertainty that can be improved by additional data, e.g., by training the machine learning model on more data or on different data. That is, the model could have generated a more accurate prediction for a given input had the model been trained differently.

The lack of ability to distinguish between these two types of uncertainty can prevent conventional models from being deployed in many real-world situations that require reliable predictions.

For example, robots or other agents can be controlled more effectively if the outputs of the policy model for the agent indicate whether the model is unsure about which action to take in a given state because the state is ambiguous or because the model has not been trained on the appropriate data.

As another example, image classification outputs can be more effectively incorporated into a real-world system that makes decisions based on the outputs if information is available indicating whether the underlying image is ambiguous or whether the model needs to be trained on more data to make an effective prediction.

This specification describes techniques for augmenting a conventional machine learning model (referred to as a “base machine learning model”) with an epistemic machine learning model. Making use of the epistemic model allows a final output that is generated based on the output of the conventional model and the epistemic model to provide an indication of whether a given output is generated as a result of epistemic or aleatoric uncertainty.

Additionally, generally, the epistemic model consumes significantly fewer resources than the base model, which can be large language model, a large computer vision model, or other model that has millions and, in some cases, billions of parameters. Thus, augmenting the base model with the outputs generated by the epistemic model can provide information about the uncertainty in the predictions of the base model with relatively little additional computational overhead.

In particular, the described techniques for generating final outputs better reflect uncertainty than existing techniques while being significantly more computationally efficient than the existing techniques. This is because incorporating uncertainty information using the described techniques requires only one or more forward passes through a model or models that consume a relatively small amount of computational resources rather than requiring additional forward passes through the computationally expensive base model.

For example, the described techniques can provide improved uncertainty indications relative to ensembles of multiple models. In particular, the described techniques can outperform ensembles of hundreds of models at a computational cost less than that of an ensemble with two models.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a diagram of an example machine learning system.

FIG. 2 shows an example architecture of uncertainty indications provided by the outputs of a conventional model and an epistemic model.

FIG. 3 shows an example of the operations performed by the machine learning system.

FIG. 4 is a flow diagram of an example process for processing a model input.

FIG. 5 shows an example of results achieved by the machine learning system.

Like reference numbers and designations in the various drawings indicate like elements.

### DETAILED DESCRIPTION

This specification describes a system implemented as computer programs on one or more computers that performs a machine learning task by processing inputs using an epistemic machine learning model.

The machine learning task performed by the system can be any appropriate machine learning task.

For example, the machine learning task can be a computer vision task (also referred to as an “image processing task”). In other words, the epistemic machine learning model includes a convolutional neural network or different type of neural network (e.g., a transformer based neural network) that is configured to receive at least one input image (such as image(s) captured by a camera; a still camera or a video camera) and to process the input image to generate a model output for the input image, i.e., to perform some kind of image processing task. In this specification, processing an input image refers to processing the intensity values of the pixels of the image using a machine learning model.

For example, the task may be image classification and the output generated by the system for a given image may be respective scores for each of a set of object categories, with each score representing an estimated likelihood that the image contains an image of an object belonging to the category.

As another example, the task can be image embedding generation and the output generated by the system can be a numeric embedding of the input image.

As yet another example, the task can be object detection and the output generated by the system can identify locations in the input image, e.g., bounding boxes or other geometric regions within the image, at which particular types of objects are depicted.

As yet another example, the task can be image segmentation and the output generated by the system can define for each pixel of the input image which of multiple categories the pixel belongs to.

More generally, however, the task can be any of a variety of tasks, including tasks that process inputs other than images.

As an example, if the inputs to the system are Internet resources (e.g., web pages), documents, or portions of documents or features extracted from Internet resources, documents, or portions of documents, the task can be to classify the resource or document, i.e., the output generated by the model for a given Internet resource, document, or portion of a document may be a score for each of a set of topics, with each score representing an estimated likelihood that the Internet resource, document, or document portion is about the topic.

As another example, if the inputs to the system are features of an impression context for a particular advertisement, the output generated by the model may be a score that represents an estimated likelihood that the particular advertisement will be clicked on.

As another example, if the inputs to the system are features of a personalized recommendation for a user, e.g., one or more of features characterizing the context for the recommendation, features characterizing previous actions taken by the user, or features characterizing the user, the output generated by the model may be a score for each of a set of content items, with each score representing an estimated likelihood that the user will respond favorably to being recommended the content item. The content items may be, e.g., videos, software applications, electronic documents, e.g., ebooks, advertisements, and so on.

As another example, if the input to the system is a sequence of text in one language, the output generated by the model may be a score for each of a set of pieces of text in another language, with each score representing an estimated likelihood that the piece of text in the other language is a proper translation of the input text into the other language.

As another example, the task may be an audio processing task. For example, if the input to the system is a sequence representing a spoken utterance (e.g. as captured by a microphone), the output generated by the system may be a score for each of a set of pieces of text, each score representing an estimated likelihood that the piece of text is the correct transcript for the utterance. As another example, the task may be a keyword spotting task where, if the input to the system is a sequence representing a spoken utterance, the output generated by the system can indicate whether a particular word or phrase (“hotword”) was spoken in the utterance. As another example, if the input to the system is a sequence representing a spoken utterance, the output generated by the system can identify the natural language in which the utterance was spoken.

As another example, the task can be a natural language processing or understanding task, e.g., an entailment task, a paraphrase task, a textual similarity task, a sentiment task, a sentence completion task, a grammaticality task, and so on, that operates on a sequence of text in some natural language.

As another example, the task can be a text to speech task, where the input is text in a natural language or features of text in a natural language and the model output is a spectrogram or other data defining audio of the text being spoken in the natural language.

As another example, the task can be a health prediction task, where the input is electronic health record data for a patient and the output is a prediction that is relevant to the future health of the patient, e.g., a predicted treatment that should be prescribed to the patient, the likelihood that an adverse health event will occur to the patient, or a predicted diagnosis for the patient.

As another example, the task can be an agent control task, where the input is an observation characterizing the state of an environment and the output defines an action to be performed by the agent in response to the observation.

For example, the output can be a respective score for each action in a set of actions that can be performed by the agent, can assign a respective Q value to each action in the set of actions, can specify a probability distribution over a set of actions, or can directly regress the action to be performed by the agent.

The agent can be, e.g., a mechanical agent, e.g., a robot or an autonomous vehicle interacting with a real-world environment (in this case, the observation may include the outputs of one or more sensor(s), e.g. camera(s), sensing the real-world environment, and the action may be for the mechanical agent to move within the environment and/or change its configuration), a software agent, e.g., a computer simulation of a robot or an autonomous vehicle interacting in a computer simulation of a real-world environment, a control system for an industrial facility (e.g. controlling a heating and/or cooling system of the industrial facility, or controlling production equipment in the facility, and the observations may comprise temperature and/or power consumption observations of one or more locations in the facility), a system for distributing resources (e.g. electrical power or computing resources) between multiple systems configured to employ those resources, or a control system that controls a different kind of agent.

In some cases, the machine learning task is a combination of multiple individual machine learning tasks, i.e., the neural network is configured to perform multiple different individual machine learning tasks, e.g., two or more of the machine learning tasks mentioned above. For example, the neural network can be configured to perform multiple individual natural language understanding tasks. Optionally, the network input can include an identifier for the individual natural language understanding task to be performed on the network input. As another example, the neural network can be configured to perform multiple individual image processing or computer vision tasks, i.e., by generating the output for the multiple different individual image processing tasks in parallel by processing a single input image.

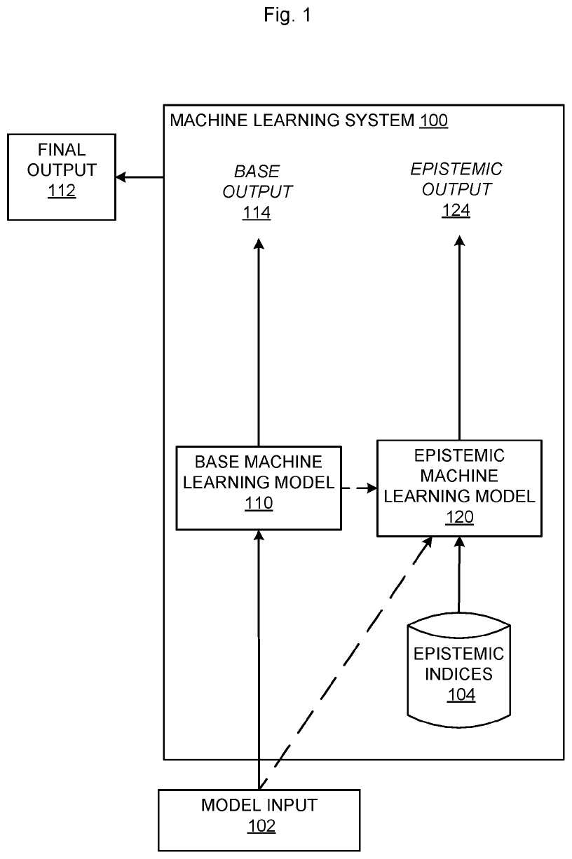

FIG. 1 is a diagram of an example machine learning system 100. The machine learning system 100 is an example of a system implemented as computer programs on one or more computers in one or more locations, in which the systems, components, and techniques described below can be implemented.

The system 100 receives model inputs 102 for a machine learning task, e.g., the input data for one of the tasks described above (e.g. image data if the task is an image processing task), and processes the model inputs to generate final outputs 112 for the task.

In particular, when the system 100 receives a new model input 102, the system 100 processes the new model input 102 using a base machine learning model 110 to generate a base output 114 for the machine learning task for the new model input 102.

For example, when the machine learning task is a classification task, the base output 114 can include a respective logit, e.g., a respective score, for each of a set of categories for the classification task, e.g. a logit indicative of the likelihood that the new model input is in that category.

As another example, when the machine learning task is a regression task, the base output 114 can include one or more regressed values.

The base machine learning model 110 can be any appropriate model that is configured to and has been trained to perform the machine learning task.

Examples of machine learning models include random forest, support vector machines, gradient boosted trees, decision forests, decision trees, logistic regression models, and neural networks.

While conventional systems would provide the base output 114 of the base model 110 as the final output 112 for the model input 102, the system 100 also makes use of an epistemic machine learning model 120 in order to improve the quality of the base output 114 to more effectively account for uncertainty in the predictions generated by the base model 110.

In particular, the system 100 samples a set of one or more indices 104 from a reference distribution over possible indices.

In some implementations, each possible index is a scalar value and the reference distribution is, e.g., a uniform distribution over a discrete set of possible indices or Gaussian distribution over a space of possible indices.

In some other implementations, each possible index is a vector having a fixed dimensionality and the reference distribution is, e.g., a multi-dimensional Gaussian distribution over a multi-dimensional space of possible indices or a uniform distribution over a discrete set of multi-dimensional vectors.

Generally, the sampling of the indices is independent of the new model input 102. That is, the system 100 samples from the same fixed reference distribution for each model input that is processed by the system 100.

In some cases, the system 100 samples a fixed number of indices for each input. In some other cases, the system 100 can determine how many indices to sample for a given input based on some criteria. For example, the system 100 can sample the maximum number of indices that would result in a computational cost that does not exceed the amount of available compute for generating the final output 112 for the new model input 102.

For each of the one or more sampled indices 104 in the set, the system 100 processes an epistemic input that includes the sampled index 104 and (i) the new model input 102, (ii) data derived from the new model input 102, or (iii) both using the epistemic machine learning model 120 to generate an epistemic output 124 for the machine learning task for the new model input 102.

Each epistemic output 124 has the same format as the base output, i.e., has the number and type of values required by the machine learning task.

That is, each epistemic input includes the new model input, data derived from the new model input, or both and an additional input that is independent of the new model input−the sampled index.

In some cases, as will be described in more detail below, the data derived from the new model input can be an intermediate representation of the model input 102 that is generated by the base model 110 while processing the model input 102.

The system 100 then generates a final output 112 for the machine learning task from at least the base output 114 for the machine learning task and the epistemic output(s) 124 for the set of one or more sampled indices.

Unlike the epistemic input, the base model input that is processed by the base model 110 does not include any sampled indices. Thus, because the base output 114 is independent of the sampled indices, when the system 100 samples multiple indices, the system 100 still only needs to perform a forward pass through the base model 110 once in order generate the final output 112.

In some implementations, the system 100 also uses a prior epistemic machine learning model that is not trained to process a prior input that includes the sampled index and (i) the new model input, (ii) data derived from the new model input, or (iii) both to generate a prior output and generates the final output 112 using the base output, the epistemic outputs, and the prior outputs.

The epistemic model 120 will also be referred to in this specification as a learnable epistemic model, to distinguish from the prior epistemic machine learning model which is not learnable, i.e., because it has not undergone any training.

Like the base model, the epistemic model 120 and, when used, the prior model can be any appropriate machine learning model and can be the same type of model or a different type of model relative to the base model 110.

Generally, the epistemic model 120 and, when used, the prior model consume significantly fewer resources than the base model 110.

For example, the base model 110 can be large language model, a large computer vision model, e.g., a convolutional neural network or a Vision Transformer, or other model that has millions and, in some cases, billions of parameters while the epistemic and prior models are relatively smaller neural networks that have significantly fewer parameters, e.g., thousands or hundreds of thousands of parameters. For example the ratio of variable parameters defining the epistemic model 120 and, if present, prior model, may be a factor of at least 1000, or at least at 10,000 times, fewer than those defining the base model 110.

Thus, augmenting the base model 110 with the outputs generated by the epistemic model 120 and, optionally, prior model can provide information about the uncertainty in the predictions of the base model 110 with relatively little additional computational overhead.

In particular, the described techniques for generating final outputs 112 better reflect uncertainty than existing techniques while being significantly more computationally efficient than the existing techniques.

This is because incorporating uncertainty information requires only one or more additional forward passes through a model or models, i.e., through the epistemic model 120 and optionally the prior model, that consume a relatively small amount of computational resources rather than requiring additional forward passes through the computationally expensive base model 110.

When a single index 104 is sampled, the system 100 generates a combined output by combining the base output, the epistemic output, and, optionally, the prior output. For example, the system can compute a sum of the base output, the epistemic output and, optionally, the prior output. As another example, the system can assign a weight to the base output, the epistemic output, and, optionally, the prior output, and then compute a weighted sum of the outputs.

The system then provides the combined output as the final output 112. As will be described below, even when only a single index 104 is sampled, the use of the sampled index and the epistemic model improves how well the combined outputs reflect epistemic uncertainty, e.g., because the combined outputs more accurately model joint probability distributions than the base outputs.

When multiple indices are sampled, the system 100 generates a respective combined output for each sampled index as described above.

The system 100 can then use the respective combined outputs to generate the final output 112 for the machine learning task in any of a variety of ways.

For example, the system 100 can generate an uncertainty estimate from the respective combined outputs and provide the uncertainty estimate as part of the final output 112.

The uncertainty estimate can be, e.g., based on a measure of a spread of a distribution of the outputs, e.g., the variance or the standard deviation.

Alternatively, the uncertainty estimate can instead be based on individual uncertainty estimates for logits for individual classes or for individual regressed values that are generated based on the variance of the corresponding logit or regressed value across the combined outputs. That is, the system can compute a separate individual uncertainty estimate for each logit or each regressed value that is included in the combined output.

As another example, the system 100 can compute a measure of central tendency, e.g., minimum, maximum, or average, of the combined outputs and then provide the resulting measure as part of the final output 112.

That is, the system 100 can provide the resulting measure as a final combined output and, optionally, can also provide the measure of uncertainty (“uncertainty estimate”) along with the final combined output as the final output 112 or can use the measure of uncertainty to modify the final combined output and then provide the modified combined output as the final output 112 (with or without the measure of uncertainty).

Making use of the epistemic machine learning model 120 and, optionally, the prior machine learning model to augment the machine learning model can improve the operation of the system 100 in any of a variety of ways.

For example, in many applications, e.g., safety critical applications like controlling a robot or autonomous vehicle or performing classification of medical images or images captured by the sensors of a robot, autonomous vehicle, or other agent, the system 100 may need to employ a risk management scheme that penalizes outputs that are uncertain. In these applications, the system 100 can generate, from the combined outputs and the uncertainty estimate, a respective modifier for each logit or regressed value. The modifiers reduce the logits or regressed values by assigning a penalty to logits or regressed values that vary more across the sampled indices and then use the modified output as the final output for the task. For example, the modifier for a given logit or regressed value can be the output of a function applied to the individual uncertainty estimate for the logit or regressed value, e.g., an increasing function that scales the logit or regressed value or that normalizes the logit or regressed value. As another example, the modifier may be a fixed value that is assigned only to the subset of logits or regressed values with highest uncertainty estimates or only to the subset of logits or regressed values with uncertainty estimates above a threshold.

As another example, in many cases, e.g., during training of a model for controlling an agent or for making content recommendations, it is important to explore the space of possible actions, the environment, or both.

In some of these implementations, the system can generate, from the combined outputs, a respective modifier for each logit or regressed value that gives a bonus to, i.e., that increases, values that vary more across the sampled indices and then uses the modified output as the final output for the task. For example, the bonus for a given logit or regressed value can be the output of a function applied to the individual uncertainty estimate for the logit or regressed value, e.g., an increasing function that scales the logit or regressed value or that normalizes the logit or regressed value. As another example, the bonus may be a fixed value that is assigned only to the subset of logits or regressed values with highest uncertainty estimates or only to the subset of logits or regressed values with uncertainty estimates above a threshold.

In others of these implementations, when the outputs include respective scores, e.g., Q values or logits for actions to be performed by an agent, the system can select an action using the measures of uncertainty for the actions rather than using the measure of central tendency for the combined output, e.g., so that actions with higher measures of uncertainty are more likely to be selected than actions that have lower measures of uncertainty.

In other words, in any of the above implementations where exploring is important, the system uses the final output to select an action that causes the agent to explore the environment.

As another example, the system can determine how to generate additional training data for the base model, the epistemic model, or both based on the uncertainty estimate computed from the combined outputs. For example, when the combined output for a given new model input has high uncertainty, the system can query to generate more training examples that are similar to the new model input. As a particular example, when controlling an agent, the system can control the agent to reach states of the environment that are characterized by observations that are similar to the one that resulted in a high uncertainty estimate.

As another example, the system may be performing the process of generating a final output as part of training the base model, the epistemic model, or both, e.g., during online learning to fine-tune a pre-trained model. In this example, the system can determine the learning rate that is used when training on the new model input based on the uncertainty measure for the combined output, e.g., to allow the system to adapt faster to new data on which the model is uncertain and therefore perform the online learning in fewer training steps and while consuming fewer computational resources, e.g., consuming fewer processor cycles and less memory. That is, the system can assign a higher learning rate to model inputs that have uncertainty measures that indicate a higher uncertainty.

As another example, for safety critical applications, the system can generate an alert to be provided to a user of the system based on the measure of uncertainty that is computed from the combined outputs. That is, the system can alert the user when the measure of uncertainty exceeds a threshold value to indicate that output is not likely to be reliable.

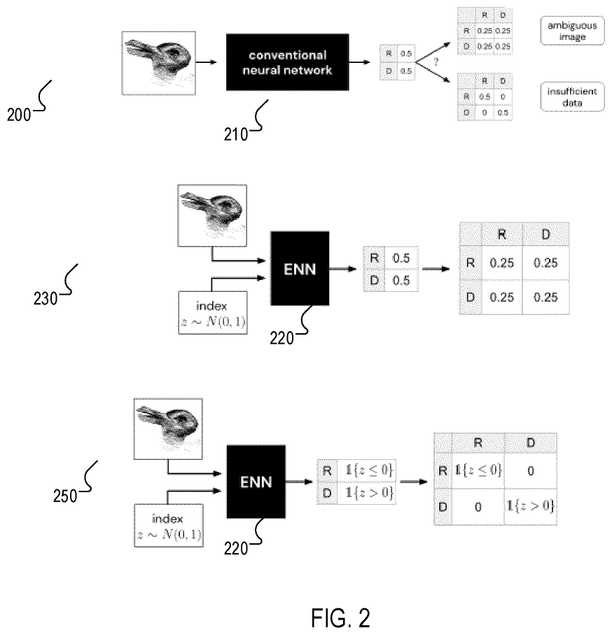

FIG. 2 shows examples of the example model input by a conventional neural network 210, e.g., the base model 110, as well as one that has been augmented with an epistemic model and, optionally, a prior model to generate an epistemic neural network (ENN) 220.

In the example of FIG. 2, the model inputs are images and the task is image classification and, in particular, requires classifying input images as either being images of a rabbit (R) or a duck (D).

In example 200, only the conventional neural network 210 is used and the conventional neural network 210 generates an output that includes a score for 0.5 for R and a score of 0.5 for D.

In this example, it is not clear from the output whether the image is an ambiguous image, i.e., it cannot be readily discerned whether the image is of a rabbit or a duck, or whether there is insufficient data for the conventional neural network 210 to accurately classify the image. That is, whether the image is ambiguous or the image is not ambiguous but the conventional neural network 210 has not been trained on enough training data or the appropriate type of training data in order to accurately classify the image.

In particular, as shown in FIG. 2, given a single image, the network 210 outputs a marginal prediction that assigns probabilities to the two classes. If the probabilities are each 0.5, as in the example 200, it remains unclear whether this is because the image is ambiguous and user opinions about the correct classifications are equally divided or the neural network would settle on one class if trained on more data.

To illustrate this, the two tables to the right of the neural network output represent possible joint distributions over labels of two identical images. That is, one cell represents a joint probability of assigning R to both images, another cell represents the joint probability of assigning R to the first image and D to the second image, another cell represents the joint probability of assigning D to the first image and D to the second image, and another cell represents a joint probability of assigning D to both images.

Both tables are consistent with the uniform marginal distribution. The first table indicates inevitable ambiguity that would not be resolved through training on additional data, e.g., because conditioning on the first image label does not alter the distribution of the second. The second table indicates that additional training should resolve uncertainty, e.g., because, conditioned on the first label, the distribution of the second label assigns all probability to the same outcome as the first.

FIG. 2 also shows the impact of augmenting the conventional neural network 210 with an epistemic machine learning model that receives an index z sampled from a reference distribution to generate an ENN 220.

Example 230 shows that, when the image is ambiguous, the probability for the image does not change by sampling a different z. That is, as shown in FIG. 2, even with multiple samples z, the probabilities remain 0.5 for R and 0.5 for D. This indicates that the image is ambiguous and that further training would not improve the performance of the ENN 220 in accurately classifying the image, i.e., that the underlying table of joint probabilities assigns an equal probability of 0.25 to each cell.

Example 250 shows that, when the image is not ambiguous but the ENN 220 has been trained on insufficient data, the probability for R and the probability for D does depend on the sampled z. In the example of FIG. 2, the ENN 220 assigns a probability of 1 to R when z is less than or equal to zero and a probability of 1 to D when z is greater than zero. This dependency on z indicates that there exists an epistemic uncertainty in the data that the ENN 220 has been trained on, rather than an inherent irresolvable ambiguity in the input. In other words, the underlying table of joint probabilities assigns a joint probability of 1 to both images being R when z is less than or equal to zero and assigns a joint probability of 1 to both images being D when z is greater than zero.

Thus, by using the ENN 220 instead of just the conventional neural network 210, the system can generate final outputs that accurately characterize the uncertainty in, and the reliability of, the outputs generated by the system.

More generally, given inputs x₁, . . . x_{T}, a joint prediction assigns a probability \hat{P}_{1:T}(γ_{1:T}) to each class combination γ₁, . . . γ_{T}. While conventional neural networks are not designed to provide joint predictions, joint predictions can be produced by multiplying marginal predictions:

\hat{P}_{1:T}(γ_{1:T})=Πₜ₌₁^{T} softmax(ƒ_{θ}(xₜ))_{γ}_{ₜ}
where ƒ_{θ}(xₜ, z)_{γ}_{ₜ} is the score for γₜ in the combined output for xₜ.

However, this representation models each outcome as independent and therefore fails to distinguish ambiguity from insufficiency of data. ENNs address this by enabling more expressive joint predictions through integrating over epistemic indices z:

\hat{P}_{1:T}=∫P_{z}(dz)Πₜ₌₁^{T}softmax(ƒ_{θ}(xₜ,z))_{γ}_{ₜ}, where the integral is over z and ƒ_{θ}(xₜ, z)_{γ}_{ₜ} is the score for γₜ in the combined output for xₜ.

This integration introduces dependencies so that joint predictions are not necessarily just the product of marginals.

Examples 230 and 250 provide a simple example of how

two different ENNs can use the epistemic index to distinguish the types of uncertainty described above.

In example 230, the ENN makes marginal predictions that do not vary with z, and so the resultant joint predictions are simply the independent product of marginals. This corresponds to an ‘aleatoric’ or ‘irreducible’ form of uncertainty that cannot be resolved with data.

On the other hand, example 250 shows an ENN that makes different predictions depending on the sign of the epistemic index. This corresponds to ‘epistemic’ or ‘reducible’ uncertainty that can be resolved with data. In this case, integrating the 2×2 matrix over z produces a diagonal matrix with ½ in each diagonal entry.

Prior to using the base model 110 and the epistemic model 120, the system 100 or another training system trains the base model 110 and the epistemic model 120 on training data.

In some implementations, the base model 110 is pre-trained, e.g., on an appropriate objective function for the machine learning task. After the base model 110 is trained, the training system trains the epistemic model 120 while holding the base model 110 fixed. Holding the base model 110 fixed refers to keeping the values of the parameters of the base model 110 fixed, i.e., fixed to the same value, throughout the training of the epistemic model 120. For example, the training system can train the epistemic model 120 on the same objective function for the machine learning task that was used to train the base model 110.

In some other implementations, the training system trains the base model 110 and the epistemic model 120 jointly on the objective function for the machine learning task. That is, during the training, updates to the variable parameters of the base model may be substantially simultaneous with, or interleaved with, corresponding updates to the epistemic model). For example, during the joint training, gradients of the objective function for the same training input can be used to update the base model and the epistemic model.

Examples of objective functions can include cross-entropy losses, squared error losses, negative log likelihood losses, and so on. In some cases, the task loss function may also include one or more additional terms, e.g., auxiliary loss terms, regularization terms, and so on, that do not depend on the label for the given input.

As a particular example, the objective function can be a marginal objective function that only depends on a single input. For example, if the learning is performed based on minimizing the objective function, and the training of the base model was based on a number of input-output training examples ({xₜ, γₜ} indexed by a value t), the objective function may be such that minimizing the objective function increases the likelihood that when the input to the epistemic machine learning model 120 is (xₜ, z) for one training example t and where z is a sample of the one or more indices, the output of the epistemic machine learning model 120 is γₜ.

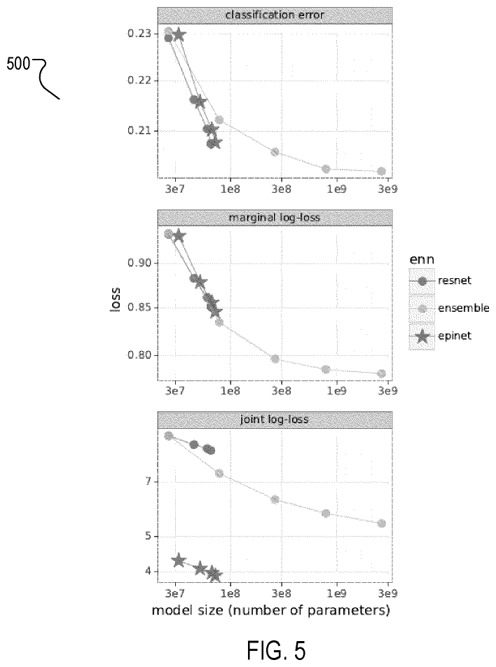

Even though the objective function is a marginal objective function, the final outputs generated by the system 100 can accurately model joint probabilities after training due to the inclusion of the epistemic machine learning model 120. An example of the performance of the system 100 in modeling joint probabilities after training on a marginal objective function is shown below with reference to FIG. 5.

In cases where the training system trains the base model 110 and the epistemic model 120 jointly and the epistemic model 120 receives as input an internal representation generated by the base model 110, to improve the stability of the training, the training system can apply a stop gradient function on the internal representation. A “stop gradient” indicates that the argument to the function is treated as fixed when computing a gradient.

Before training, variation of the combined output as a function of z reflects prior uncertainty in predictions. Since the base model 110 does not depend on z, this variation must derive from the epistemic model 120. By incorporating the base model as described above, the training system can induce this initial variation.

That is, the prior model represents prior uncertainty and has no trainable parameters. The learnable epistemic model can be initialized to output values close to zero, e.g., using Glorot initialization or a different initialization scheme, but is then trained so that the combined output produces statistically plausible predictions for all probable values of z. Variations of a combination input x as a function of z indicate predictive epistemic uncertainty, as in example 250.

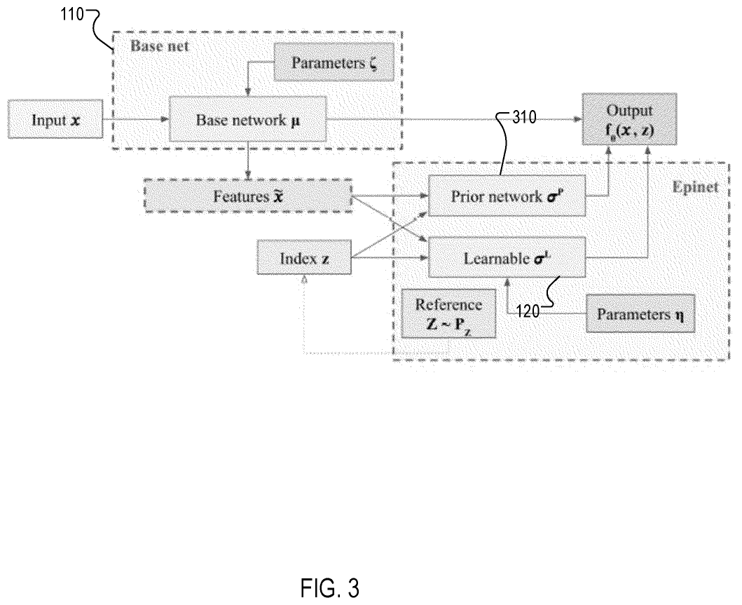

FIG. 3 shows an example of the operation of the system 100 when the system 100 includes the base model 110, the (learnable) epistemic model 120, and a prior epistemic model 310.

In particular, in the example of FIG. 3, the system 100 receives the model input 102 and processes the model input 102 using the base model 110 to generate a base output for the model input 102.

As part of processing the model input 102, the base model 110 generates features of the model input 102. The features of the model input 102 are an internal representation of the model input 102 that is generated by the base model 110.

For example, when the base model 110 is a neural network, the features can be the output of one or more hidden layers of the neural network. As a particular example, the features can be the output of the last hidden layer of the neural network, e.g., the last convolutional layer in the neural network, the last Transformer layer in the neural network, and so on.

The learnable epistemic model 120 processes the features generated by the base model 110 and an index z sampled from a reference distribution Pz to generate an epistemic output.

As described above, the epistemic model 120 is generally less computationally expensive than the base model 110. That is, the epistemic model 120 is more computationally efficient than the base model 110, e.g., because the epistemic model 120 has fewer weights than the base mode 1110.

For example, the epistemic model 120 can be a multi-layer perceptron (MLP) that processes a concatenation of the features and the index z. As another example, the epistemic model 120 can be a convolutional neural network that processes a spatial grid of the features concatenated with another spatial grid that is generated by broadcasting the index z.

The prior epistemic model 310 processes the features generated by the base model 110 and the index z to generate a prior output.

As described above, the prior model 310 is not learnable and is incorporated into the system 100 to induce variability with respect to the indices z from the outset of the training of the epistemic model 120.

That is, the prior machine learning model 110 has weights that are fixed to randomly initialized values. In other words, the system 100 or the other training system initializes the weights of the prior model 310 at the outset of the training of the epistemic model 120 and then keeps the weights fixed throughout the training of the epistemic model 120 and after training.

The prior model 310 can have any of a variety of architectures.

As one example, the prior model 310 can have the same architecture as the epistemic model 120 but with weights that are held fixed rather than adjusted during training. In some of these examples, the weights of the prior and epistemic models are initialized to different values at the outset of the training.

As another example, the prior model 310 can be composed of multiple individual models.

For example, the prior model 310 can include a first prior machine learning model that receives the epistemic input, i.e., the same input as the epistemic model 120, and an ensemble of second prior machine learning models that receive the new model input and, optionally, the one or more sampled indices.

In this example, the first prior model can have the same architecture as the epistemic model 120.

The ensemble of second prior models can have any appropriate architecture, e.g., convolutional neural networks, MLPs, and so on. Making use of the ensemble of second prior models can improve the performance of the system, e.g., in cases where model inputs are high-dimensional, e.g., large images or other sensor data, and the internal representation received by the epistemic model is a lower-dimensional representation of the inputs. That is, making use of ensembles of small models that are not trained but that receive the full input can allow a more computationally efficient epistemic model to be effectively trained.

As another example, the prior model 310 can be an ensemble of multiple models that each receive the epistemic input. In this example, the prior models 310 in the ensemble can all have the same architecture but differently initialized weights.

For each z, The system 100 then combines the base output, the epistemic output, and the prior output to generate a combined output. For example, the system can sum the base output, the epistemic output, and the prior output to generate the combined output. When there are multiple samples of z, the system 100 can include a measure of uncertainty in addition to a final combined output generated from all of the samples in the final output. As yet another example, the system 100 can use the measure of uncertainty to modify the final combined output to generate the final output.

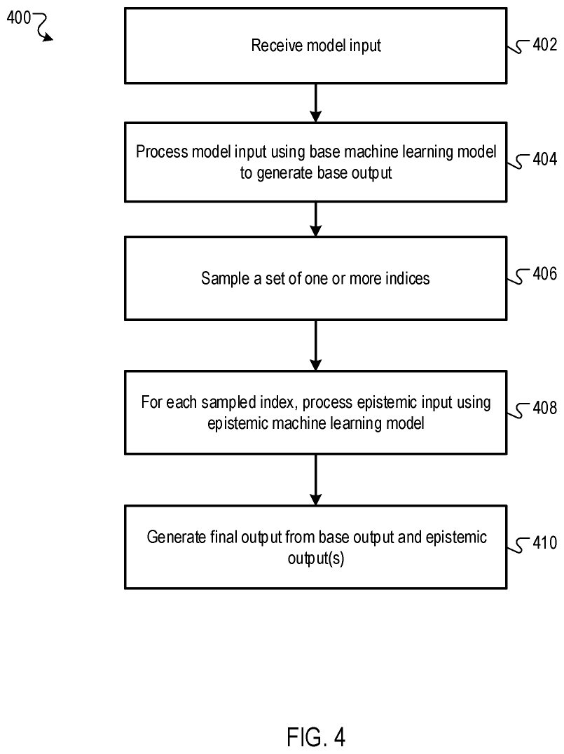

FIG. 4 is a flow diagram of an example process 400 for processing a model input to generate a final model output. For convenience, the process 400 will be described as being performed by a system of one or more computers located in one or more locations. For example, a machine learning system, e.g., the machine learning system 100 depicted in FIG. 1, appropriately programmed in accordance with this specification, can perform the process 400.

The system receives a new model input (step 402).

The system processes the new model input using a base machine learning model to generate a base output for a machine learning task for the new model input (step 404).

The system samples a set of one or more indices from a reference distribution over indices (step 406).

For each of the one or more sampled indices in the set, the system processes an epistemic input that includes the sampled index and (i) the new model input, (ii) data derived from the new model input, or (iii) both using an epistemic machine learning model to generate an epistemic output for the machine learning task for the new model input (step 406).

The system generates a final output for the machine learning task from at least the base output for the machine learning task and the epistemic outputs for the set of one or more sampled indices (step 408).

In particular, as described above, the system can optionally also use a prior epistemic machine learning model that is not trained to process a prior input that includes the sampled index and (i) the new model input, (ii) data derived from the new model input, or (iii) both to generate a prior output and generates the final output using the base output, the epistemic outputs, and the prior outputs.

FIG. 5 shows an example 500 of the results achieved by the machine learning system 100 relative to two conventional systems.

In particular, FIG. 5 shows results achieved by the machine learning system 100 (“epinet”) relative to a single base neural network (“ResNet”) and an ensemble of base neural networks (“ensemble”) on an image classification task.

FIG. 5 shows the performance of systems with different total numbers of parameters with respect to three different performance measures: classification accuracy, marginal log loss, and joint log loss. The marginal log loss measures the logarithm of the value of the marginal loss function, e.g., cross-entropy, on which the models were trained. The joint log loss measures the logarithm of the value of a joint loss function that measures joint probabilities assigned to sequences of inputs (and is not the loss function on which the models were trained).

As can be seen from FIG. 5, given the same number of parameters, the EpiNet achieves similar classification accuracy and marginal log loss as the other two system, but achieves a significantly lower (better) joint log loss than the other two systems. In particular, the system achieves a significantly better joint log loss than an ensemble with significantly more parameters (and therefore a significantly higher computational cost).

Because many real-world tasks require accurate joint predictions, e.g., to facilitate real-world decision making or exploration, the results of FIG. 5 show that the system 100 can effectively be used for real-world decision making at a fraction of the computational cost of a larger ensemble of models.

In particular, as described above, marginal predictions do not distinguish between ambiguity of the underlying input and insufficiency of data. However, in order to generate accurate joint predictions, the predictions generated by the model need to effectively account for input ambiguity. Thus, models that make accurate joint predictions can be effectively incorporated into real-world tasks, e.g., safety-critical tasks like robotics or autonomous driving, while models that can make accurate marginal predictions but cannot make accurate joint predictions cannot. As shown from the results in FIG. 5, the system 100 can effectively be used for real-world decision making at a fraction of the computational cost of a larger ensemble of models due to the improvement in joint prediction log loss (and comparable performance on classification accuracy and marginal log loss) relative to conventional systems.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them.

Embodiments of the subject matter described in this specification can be implemented as one or more computer programs, e.g., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, e.g., inference, workloads.

Machine learning models can be implemented and deployed using a machine learning framework, .e.g., a TensorFlow framework or a Jax framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method performed by one or more computers, the method comprising:
receiving a new model input;
processing the new model input using a base machine learning model to generate a base output for a machine learning task for the new model input;
sampling a set of one or more indices from a reference distribution over indices;
for each of the one or more sampled indices in the set:
processing an epistemic input comprising the sampled index and (i) the new model input, (ii) data derived from the new model input, or (iii) both using an epistemic machine learning model to generate an epistemic output for the machine learning task for the new model input; and
generating a final output for the machine learning task from at least the base output for the machine learning task and the epistemic outputs for the set of one or more sampled indices.

2. The method of claim 1, wherein the base model input does not include any of the sampled indices.

3. The method of claim 1, wherein the base machine learning model generates an internal representation of the new network input while generating the base model output, wherein the data derived from the model input is the internal representation, and wherein the epistemic input comprises the sampled index and (i) the internal representation or (ii) both the internal representation and the new model input.

4. The method of claim 3, wherein the base machine learning model is a neural network and wherein the internal representation is an output of one or more hidden layers of the neural network.

5. The method of claim 4, wherein the internal representation is an output of a last hidden layer of the neural network.

6. The method of claim 1, further comprising:
for each of the one or more sampled indices:
processing a prior input that comprises the sampled index and (i) the new model input, (ii) the data derived from the new model input, or (iii) both using a prior machine learning model to generate a prior output for the machine learning task for the new model input, wherein the prior machine learning model has weights that are fixed to randomly initialized values, and
wherein generating the final output for the machine learning task comprises:
generating a final output for the machine learning task from the base output for the machine learning task, the epistemic outputs for the one or more sampled indices, and the prior outputs for the one or more sampled indices.

7. The method of claim 6, wherein the prior machine learning model comprises:
(i) a first prior machine learning model that receives the epistemic input, and
(ii) an ensemble of second prior machine learning models that receive the new model input and the one or more sampled indices.

8. The method of claim 1, wherein the epistemic machine learning model is more computationally efficient than the base machine learning model.

9. The method of claim 1, wherein the set includes only one sampled index, and wherein generating the final output for the machine learning task comprises:
combining at least the base output for the machine learning task and the epistemic output for the sampled index to generate a combined output for the machine learning task; and
using the combined output as the final output for the machine learning task.

10. The method of claim 1, wherein the set includes a plurality of sampled indices and wherein generating the final output for the machine learning task comprises:
for each index, combining at least the base output for the machine learning task and the epistemic output for the sampled index to generate a combined output for the machine learning task; and
generating the final output for the machine learning task from the combined outputs for the plurality of indices.

11. The method of claim 10, wherein generating the final output comprises:
computing a measure of central tendency of the combined outputs.

12. The method of claim 10, further comprising:
generating, from the combined outputs for the plurality of indices, a measure of uncertainty for the final output.

13. The method of claim 9, wherein the base output and the epistemic output each comprise a respective logit for each of a plurality of classes, and wherein combining at least the base output for the machine learning task and the epistemic output for the sampled index to generate the final output for the machine learning task comprises:
for each class, adding at least the logit for the class from the base output and the logit for the class from the epistemic output to generate a combined logit for the class.

14. The method of claim 9, wherein the base output and the epistemic output each comprise a respective regressed value, and wherein combining at least the base output for the machine learning task and the epistemic output for the sampled index to generate the final output for the machine learning task comprises:
adding at least the respective values from the base output and the epistemic output to generate a combined regressed value.

15. The method of claim 1, wherein the epistemic machine learning model has been trained to optimize an objective function for the machine learning task while holding the base neural network fixed.

16. The method of claim 1, wherein the epistemic machine leaning model and the base neural network have been trained jointly to optimize an objective function for the machine learning task.

17. The method of claim 1, wherein the new model input is one or more images and the machine learning task is a computer vision task.

18. The method of claim 17, wherein the computer vision task is image classification and the final output comprises respective scores for each of a plurality of object categories.

19. The method of claim 1, wherein the new model input is an observation characterizing a state of the environment and the final output defines an action to be performed by an agent interacting with the environment.

20. The method of claim 19, wherein the environment is a real-world environment, the agent is a mechanical agent, and the observation comprises data from one or more sensors configured to sense the environment.

21. The method of claim 19, further comprising:
selecting an action that causes the agent to explore the environment using the final output.

22. A system comprising:
one or more computers; and
one or more storage devices storing instructions that, when executed by the one or more computers, cause the one or more computers to perform operations comprising:
receiving a new model input;
processing the new model input using a base machine learning model to generate a base output for a machine learning task for the new model input;
sampling a set of one or more indices from a reference distribution over indices;
for each of the one or more sampled indices in the set:
processing an epistemic input comprising the sampled index and (i) the new model input, (ii) data derived from the new model input, or (iii) both using an epistemic machine learning model to generate an epistemic output for the machine learning task for the new model input; and
generating a final output for the machine learning task from at least the base output for the machine learning task and the epistemic outputs for the set of one or more sampled indices.

23. One or more computer-readable storage media storing instructions that when executed by one or more computers cause the one or more computers to perform operations comprising:
receiving a new model input;
processing the new model input using a base machine learning model to generate a base output for a machine learning task for the new model input;
sampling a set of one or more indices from a reference distribution over indices;
for each of the one or more sampled indices in the set:
processing an epistemic input comprising the sampled index and (i) the new model input, (ii) data derived from the new model input, or (iii) both using an epistemic machine learning model to generate an epistemic output for the machine learning task for the new model input; and
generating a final output for the machine learning task from at least the base output for the machine learning task and the epistemic outputs for the set of one or more sampled indices.
